(19) United States
(12) Patent Application Publication
(10) Pub. No.: US 2018/0361717 A1
(43) Pub. Date: Dec. 20, 2018

(54) Heat-Resistant Laminate Structure, Construct, And Methods Of Using The Same

(71) Applicant: Graphic Packaging International, LLC, Atlanta, GA (US)

(72) Inventors: Ryan Portrey, Louisville, CO (US); Paul Abbott, Louisville, CO (US); John McDonnell, Wausau, WI (US); Michael L. Schlauch, Boulder, CO (US); Jeffrey T. Sloat, Broomfield, CO (US)

(21) Appl. No.: 16/007,288

(22) Filed: Jun. 13, 2018

Related U.S. Application Data
(60) Provisional application No. 62/519,404, filed on Jun. 14, 2017.
(60) Provisional application No. 62/587,095, filed on Nov. 16, 2017.

(51) Int. Cl. B32B 27/10; B32B 7/12; B32B 27/36; B32B 37/12

(52) U.S. Cl. CPC B32B 27/10; B32B 7/12; B32B 2439/70; B32B 37/12; B32B 2307/308; B32B 27/36

(57) ABSTRACT

A laminate structure includes a base layer, a thermally stable adhesive disposed on at least a portion of the base layer, and a thermally stable film overlying the base layer and the adhesive. The thermally stable film and the thermally stable adhesive are configured such that the laminate structure substantially resists deformation at a temperature of about 400° F. (204° C.) and above.

### CROSS-REFERENCE TO RELATED APPLICATIONS

This application claims the benefit of each of U.S. Provisional Patent Application No. 62/519,404, filed on Jun. 14, 2017, and U.S. Provisional Patent Application No. 62/587,095, filed on Nov. 16, 2017.

### INCORPORATION BY REFERENCE

The disclosures of each of U.S. Provisional Patent Application No. 62/519,404, filed on Jun. 14, 2017, and U.S. Provisional Patent Application No. 62/587,095, filed on Nov. 16, 2017, are hereby incorporated by reference for all purposes as if presented herein in their entirety.

### BACKGROUND OF THE DISCLOSURE

The present disclosure generally relates to laminate structures for forming constructs for holding one or more food products. More specifically, the present disclosure relates to a laminate structure for forming a construct for holding one or more food products and that substantially resists deformation in high temperature environments.

### SUMMARY OF THE DISCLOSURE

According to one aspect of the disclosure, a laminate structure comprises a base layer, a thermally stable adhesive disposed on at least a portion of the base layer, and a thermally stable film overlying the base layer and the adhesive. The thermally stable film and the thermally stable adhesive are configured such that the laminate structure substantially resists deformation at a temperature of about 400° F. (204° C.) and above.

According to another aspect of the disclosure, a construct for holding at least one food product comprises a press-formed laminate structure comprising a bottom and at least one sidewall extending upwardly from the sidewall and extending at least partially around an interior of the construct. The laminate structure comprises a base layer, a thermally stable adhesive disposed on at least a portion of the base layer, and a thermally stable film overlying the base layer and the adhesive. The thermally stable film and the thermally stable adhesive are configured such that the laminate structure substantially resists deformation at a temperature of about 400° F. (204° C.) and above.

According to another aspect of the disclosure, a method of forming a laminate structure comprises obtaining a base layer, disposing a thermally stable adhesive on at least a portion of the base layer, and applying a thermally stable film overlying the base layer and the adhesive. The thermally stable film and the thermally stable adhesive are configured such that the laminate structure substantially resists deformation at a temperature of about 400° F. (204° C.) and above.

### BRIEF DESCRIPTION OF THE DRAWINGS

Those skilled in the art will appreciate the above stated advantages and other advantages and benefits of various additional embodiments reading the following detailed description of the embodiments with reference to the below-listed drawing figures.

According to common practice, the various features of the drawings discussed below are not necessarily drawn to scale. Dimensions of various features and elements in the drawings may be expanded or reduced to more clearly illustrate the embodiments of the disclosure.

FIG. 1 is a schematic, perspective, parts-separated view of a laminate structure according to a first exemplary embodiment of the disclosure.

FIG. 2 is a plan view of the base layer of the laminate structure of FIG. 1.

FIG. 3 is a perspective view of the base layer of FIG. 2 being coated with adhesive.

FIG. 4 is a side view of the assembled laminate structure of FIG. 1.

FIG. 5 is a perspective view of a construct formed from the laminate structure of FIG. 1 according to the first exemplary embodiment of the disclosure.

FIG. 6 is a perspective view of the construct of FIG. 5 being subjected to a heat source.

FIG. 7 is a perspective view of a construct formed from a laminate structure according to a second exemplary embodiment of the disclosure.

FIG. 8 is a perspective view of the construct of FIG. 7 being subjected to a heat source.

Corresponding parts are designated by corresponding reference numbers throughout the drawings.

### DETAILED DESCRIPTION OF THE EXEMPLARY EMBODIMENTS

Various aspects of the disclosure may be understood further by referring to the figures. For purposes of simplicity, like numerals may be used to describe like features. It will be understood that where a plurality of similar features are depicted, not all of such features necessarily are labeled on each figure. It also will be understood that the various components used to form the constructs may be interchanged. Thus, while only certain combinations are illustrated herein, numerous other combinations and configurations are contemplated hereby.

Constructs according to the present disclosure can accommodate articles of numerous different shapes. For the purpose of illustration and not for the purpose of limiting the scope of the disclosure, the following detailed description describes articles such as food products at least partially disposed within the construct embodiments. As described herein, food products can be, for example, frozen or non-frozen food products. In this specification, the terms “lower,” “bottom,” “upper”, “top”, “front”, and “back” indicate orientations determined in relation to fully erected constructs. As described herein, constructs can be formed from blanks by overlapping multiple portions, components, and/or elements thereof. Such portions, components, and/or elements may be designated herein in terms relative to one another, e.g., “first”, “second”, “third”, etc., in sequential or non-sequential reference, without departing from the disclosure.

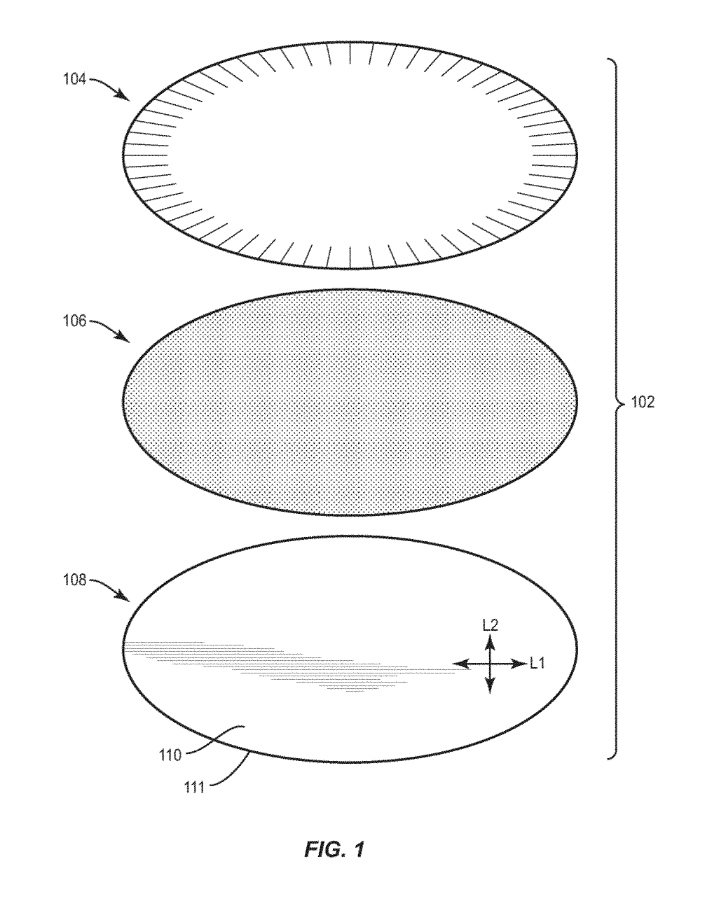

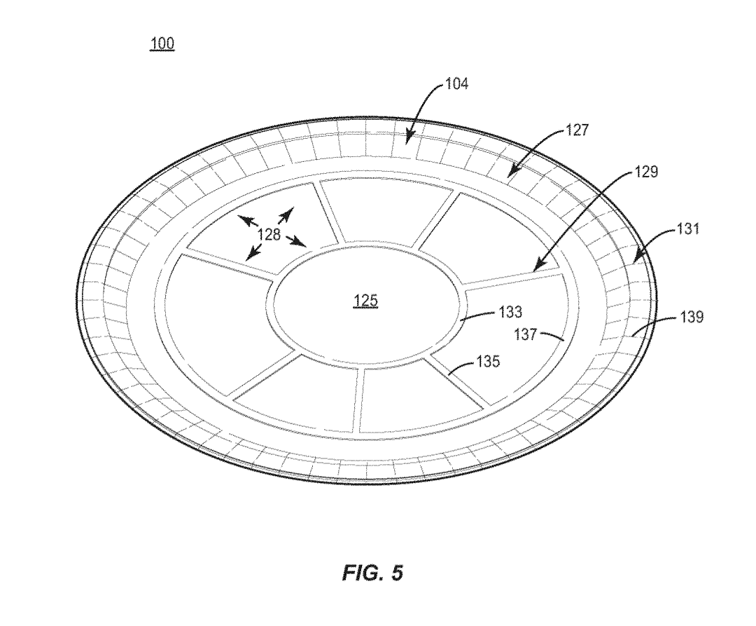

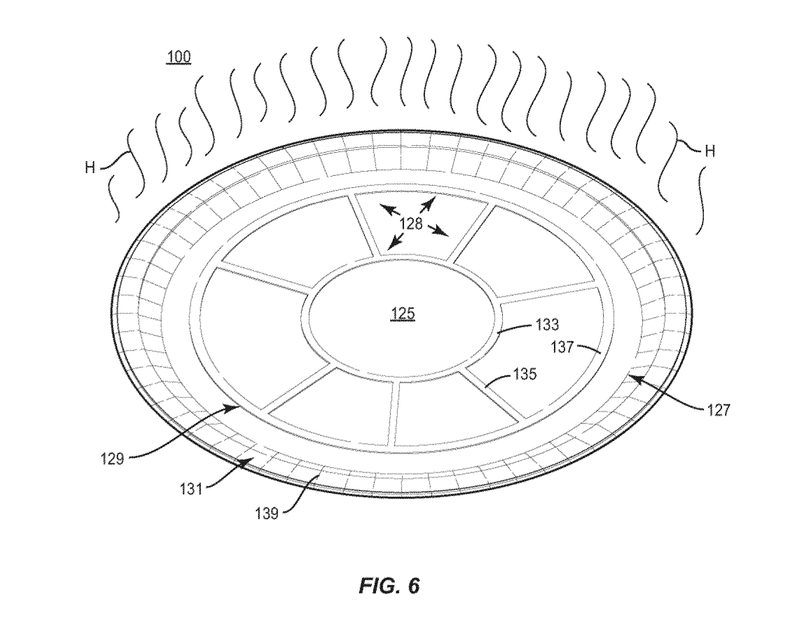

Referring to FIG. 1, a blank or laminate structure 102 for forming a construct 100 (FIG. 5) is illustrated according to a first exemplary embodiment of the disclosure. The construct 100 can be used to hold one or more food products, and can be exposed to heat so that the construct 100 can be used in heated environments having a temperature greater than room temperature, for example, in cooking applications such as in a conventional oven. It will be understood that the construct can be subjected to a heat source in a different environment, for example, a microwave oven, without departing from the disclosure. As described herein, the construct 100 can be provided with a film 104 attached to a base layer of material 108 by an adhesive 106. Both the film 104 and adhesive 106 are thermally stable such that the film 104 and the adhesive 106 each substantially maintain their integrity and dimensional and/or positional properties when exposed to heat such that the laminate structure 102 and the construct 100 are thermally stable. As described herein, thermally stable can refer to the property or properties of resistance to substantial deformation and/or weakening during exposure to high heat environments, e.g., in high temperature applications, such as temperatures at or above about 400° F. (204° C.), e.g., between about 400° F. (204° C.) and about 450° F. (232° C.).

As shown, the laminate structure 102 includes the film 104, the adhesive 106, and the base layer 108, which together can be formed into the construct 100, as described further herein.

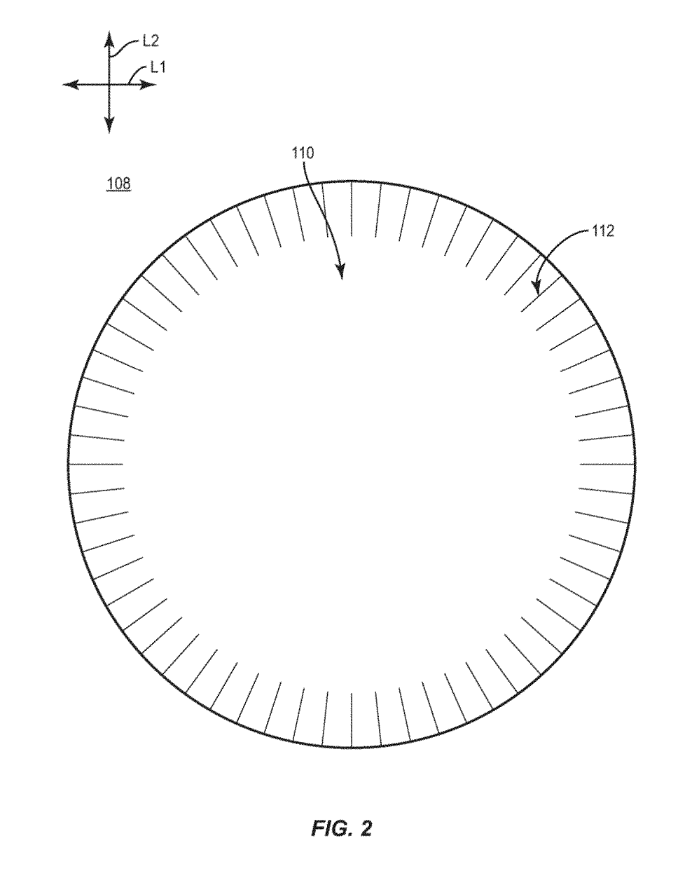

Referring additionally to FIG. 2, the interior or food-contacting surface 110 of the base layer 108 is illustrated. The base layer 108 can be a paper-based product (e.g., paperboard, cardboard, etc.) and has a longitudinal axis L1 extending along a length of the base layer 108, and a lateral axis L2 extending along a width of the base layer 108. As shown, the base layer 108 is generally circular and has a plurality of score lines 112 radially spaced therealong. The score lines 112 can be substantially uniformly spaced about the base layer 108, as illustrated, or can have a different arrangement without departing from the disclosure. As shown, the score lines 112 extend from an interior portion of the base layer 108 to an outer edge of the base layer 108. It will be understood that the base layer 108 can have a different arrangement or configuration, for example, ovoid, square, rectangular, triangular, pentagonal, hexagonal, octagonal, etc. without departing from the disclosure. In one embodiment, the base layer 108 can be devoid of score lines or can have a different arrangement of score lines.

Still referring to FIG. 1, the film 104 of the illustrated embodiment can be formed of a thermally stable material, for example, a shrink-resistant material configured to substantially maintain its integrity and dimensional and/or positional properties upon exposure to high heat or high temperature environments. As described herein, the integrity of the film 104 can refer to material properties of the film 104 such as strength (e.g., tensile strength and/or shear strength), porosity and/or fluid resistance, dimensional properties of the film 104 can refer to length, width, and/or thickness, and positional properties of the film can refer to location of the film 104 relative to other components of the laminate structure 102. The illustrated film 104 can be formed of a polymeric material 105 (FIG. 4), for example, polyester. In one embodiment, the film 104 can be a general purpose, low-shrink PET (polyethylene terephthalate) film that can have one or more optional surface treatments, for example, corona treatment or air plasma treatment. Such a film 104 can be an SM₃₀C corona treated, general purpose low-shrink film available from SKC Inc. of Covington, Ga. In another embodiment, the film 104 can be a biaxially oriented polyester film such as a FLEXPET™ F-HTF transparent polyester film available from FlexFilms (USA) Inc. of Elizabethtown, Ky. The film 104 can be provided with a thickness of between about 44 ga and about 240 ga. In one embodiment, the film 104 has a thickness of about 48 ga. The film 104 can provide barrier properties for the base layer 108, for example, resistance to the passage of fluids such as moisture, oil, and/or food runoff. The film 104 can be formed of a different material with the aforementioned properties without departing from the disclosure.

Still referring to FIG. 1, the laminate structure 102 also includes the adhesive 106 disposed between the base layer 108 and the film 104. The adhesive 106, as described herein, promotes a secure coupling of the film 104 and the base layer 108, and is configured to substantially maintain its integrity and dimensional and/or positional properties upon exposure to heat. As described herein, the integrity of the adhesive 106 can refer to material properties of the adhesive 106 such as strength (e.g., tensile strength, shear strength, and/or bond strength), rigidity, and/or viscosity, dimensional properties of the adhesive 106 can refer to the general shape (e.g., length, width, and/or thickness) of the adhesive 106, and positional properties of the adhesive 106 can refer to the location of the adhesive 106 relative to other components of the laminate structure 102, for example, as applied and/or attached to the base layer 108 and/or the film 104. In the illustrated embodiment, the adhesive 106 is formed of a polymeric material 107 (FIG. 4), for example, a crosslinked polymeric adhesive. In this regard, polymeric material 107 of the adhesive 106 can have a crosslinking agent, e.g., an additive that promotes bonding among polymer chains. The crosslinking agent can be present in an amount to provide crosslinking of the adhesive 106 up to about 5% by weight of the adhesive 106, for example, 0.25%, 0.5%, 0.75%, 1.0%, 1.25%, 1.5%, 1.75%, 2.0%, 2.25%, 2.5%, 2.75%, 3.0%, 3.25%, 3.5%, 3.75%, 4.0%, 4.25%, 4.5%, 4.75%, 5.0%, and non-integer numbers therebetween. In one embodiment, the adhesive 106 includes a crosslinking agent in an amount of about 2.5% by weight of the adhesive 106. In one embodiment, the adhesive 106 can be formed of a crosslinked polymeric adhesive having a Zinc-based crosslinking system, for example, product number 20915 available from Royal Adhesives and Sealants of South Bend, Ind. Such an adhesive 106 can have a viscosity of about 300 cP and a composition of about 57% solids and a crosslinking agent in an amount of about 2.5% by weight of the adhesive 106. A different type and/or material of adhesive with the aforementioned properties can be used without departing from the disclosure.

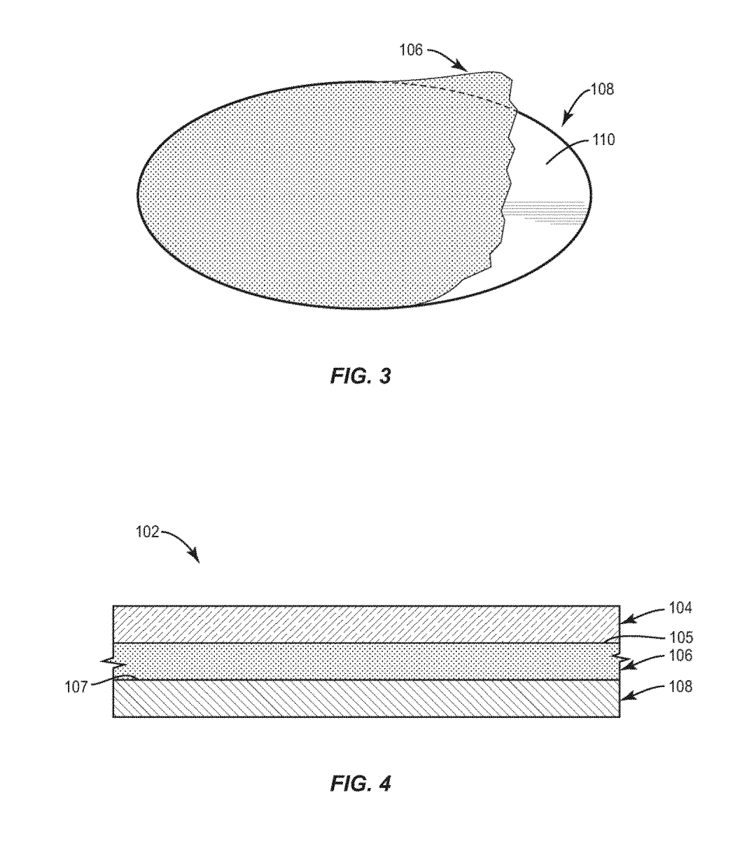

Referring additionally to FIG. 3, in one exemplary embodiment, formation of the construct 100 can include coating of the adhesive 106 onto the interior surface 110 of the base layer 108, for example, with an extruder, applicator head, or a different type of applicator structure. The adhesive 106 can be deposited such that the adhesive 106 covers the entire interior surface 110 of the base layer 108. In other embodiments, the adhesive 106 can be deposited on less than the entire interior surface 110 of the base layer 108. During deposition of the adhesive 106 on the base layer 108, the base layer 108 can move relative to the path of application of adhesive 106, for example, with a conveyor, and/or the adhesive 106 can be applied with a moveable applicator. The adhesive 106 can be applied to the base layer 108 by other methods without departing from the disclosure.

With additional reference to FIG. 4, the film 104 is applied to the base layer 108 having been coated with the adhesive 106 such that the laminate structure 102 including the base layer 108, the adhesive 106, and the film 104 is formed. The film 104, as shown, can be applied in a parallel planar arrangement with the base layer 108 following deposition of the adhesive 106 as described herein. In embodiments, the film 104 can be applied in cooperation with deposition of the adhesive 106, for example, through the use of a roller and nip. The film 104 can be applied to the base layer 108 in any other suitable manner without departing from the disclosure. It will be understood that the laminate structure 102 can be formed in a different manner without departing from the disclosure. In one embodiment, the laminate structure 102 can be assembled prior to cutting, shaping, or otherwise configuring the base layer 108, e.g., such that the base layer 108 is provided as a sheet.

Referring additionally to FIG. 5, the construct 100 formed from the laminate structure 102 is illustrated according to the first exemplary embodiment of the disclosure. The laminate structure 102 can be press-formed, for example, in a forming tool with a nose and corresponding cavity to form the construct 100 having the base layer 108 with film 104 attached to the base layer 108 by the adhesive 106. Such formation of the construct 100 can result in one or more overlapping portions at a corresponding seam. The construct 100 can be formed, as shown, to have a bottom 125, a sidewall 127 extending upwardly from the bottom 125, and a flange 131 extending outwardly from the sidewall 127. As shown, at least the bottom 125 and the sidewall 127 at least partially surround an interior 128 of the construct 100. One or more surface features 129, e.g., ridges or otherwise raised portions to support a food product and/or define compartments on the bottom 125, can be provided in the construct 100. In the illustrated construct 100, the surface features 129 can have the general arrangement of a hub and spoke, with a central hub 133 and a plurality of radially-spaced spokes 135 extending therefrom and intersecting an outer ring 137. As also shown, the laminate structure 102 can be press-formed such that portions of the base layer 108 adjacent the score lines 112 (and the corresponding portions of the adhesive 106 and the film 104) are overlapped to form pleats 139.

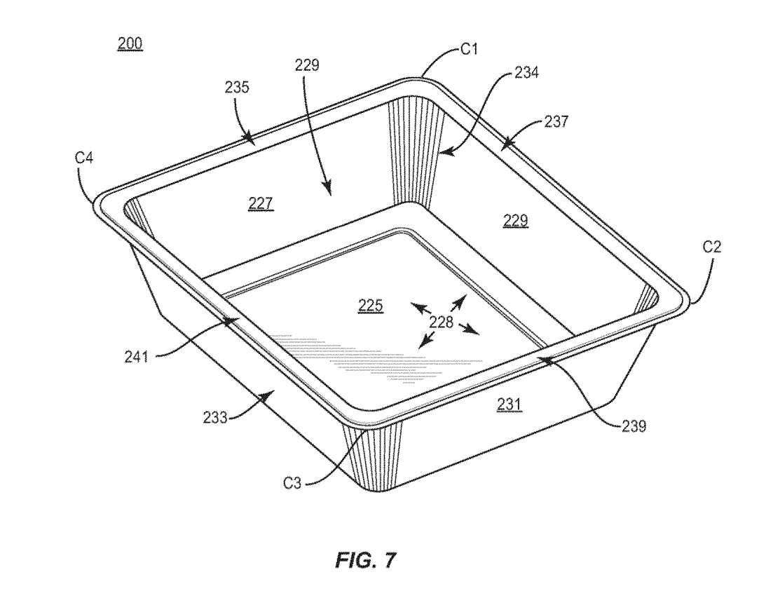

Turning to FIG. 6, and with reference to FIG. 4, in use, the construct 100 can be exposed to a heat source H, for example, a heat source generated by a convection oven or other heat source. The heat source H can provide sufficient thermal energy to maintain a high heat environment surrounding the construct 100 at a high temperature, for example, about 400° F. (204° C.) and above, e.g., between and including about 400° F. (204° C.) and about 450° F. (232° C.), for example, 400° F. (204° C.), 405° F. (207° C.), 410° F. (210° C.), 415° F. (213° C.), 420° F. (216° C.), 425° F. (218° C.), 430° F. (221° C.), 435° F. (224° C.), 440° F. (227° C.), 445° F. (229° C.), 450° F. (232° C.), or other integer or non-integer temperatures therebetween, to name a few. In one embodiment, the construct 100 can be exposed to temperatures greater than about 450° F. (232° C.).

The film 104 and the adhesive 106 are configured to substantially resist deformation at temperatures of about 400° F. (204° C.) and above. The film 104 is thermally stable such that upon exposure to a high heat or high temperature environment provided by the heat source H, the film 104 substantially maintains its integrity and dimensional and/or positional properties, for example, such that the film 104 substantially does not weaken, shrink, and/or otherwise deform so that the film 104 substantially maintains a fixed position overlying the adhesive 106 and/or the base layer 108. Further, the adhesive 106 substantially maintains its integrity and dimensional and/or positional properties in the presence of a high heat or high temperature environment provided by the heat source H such that the adhesive 106 substantially resists melting and/or other weakening or deformation such that the film 104 remains firmly attached to the base layer 108 and substantially does not slidably move along the adhesive 106. In this regard, the interface between the film 104, the adhesive 106, and the base layer 108 is substantially not disrupted at high heat or high temperature environments in the presence of heat source H such that delamination of the laminate structure 102, e.g., separation of the film 104, the adhesive 106, and/or the base layer 108, is substantially inhibited. In addition or in the alternative, at least the film 104 and the adhesive 106 are configured and arranged such that the laminate structure 102 and the construct 100 substantially resist deformation, e.g., shrinking, warping, curling, and/or disintegration, in high heat or high temperature environments, for example, temperatures greater than about 400° F. (204° C.), e.g., between about 400° F. (204° C.) and about 450° F. (232° C.). It will be understood that the construct 100 can be exposed to temperatures less than about 400° F. (204° C.) and the film 104 and adhesive 106 will maintain their respective integrity and dimensional and/or positional properties as described above. In this regard, the construct 100 includes a base layer 108 that can be, for example, paperboard, and which is provided with thermally stable properties due to the configurations of the film 104 and adhesive 106 such that the construct 100 can be subject to high heat or high temperatures, e.g., between about 400° F. (204° C.) and about 450° F. (232° C.), substantially without deformation. Such a construct 100 can thus be constructed of economical materials that can be, for example, obtained at low cost and/or discarded following use. In one embodiment, the construct 100 is a reusable product.

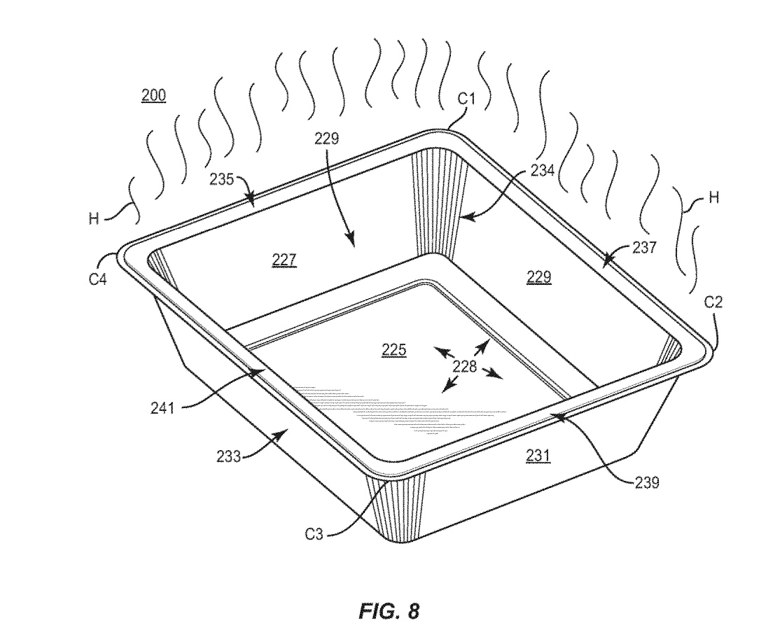

Turning now to FIG. 7, a construct 200 formed from the laminate structure 102 (FIG. 4) is illustrated according to a second exemplary embodiment of the disclosure. The construct 200 can have substantially similar properties to the construct 100 (FIG. 5) of the first exemplary embodiment of the disclosure, but is press-formed into a tray-like configuration, as shown. In this regard, the construct 200 includes a bottom 225, sidewalls 227, 229, 231, 233 extending upwardly from the bottom 225, and flanges 235, 237, 239, 241 extending outwardly from the respective sidewalls 227, 229, 231, 233. At least the bottom 225 and the sidewalls 227, 229, 231, 233 extend at least partially around an interior 228 of the construct 200. As shown, the laminate structure 102 can be press-formed such that portions of the base layer 108 (and the corresponding portions of the adhesive 106 and the film 104) are overlapped, for example, proximate score lines, to form pleats 234. As also shown, the sidewall 227 and flange 235 intersect the respective sidewall 229 and flange 237 at a corner C1, the sidewall 229 and the flange 237 intersect the sidewall 231 and the flange 239 at a corner C2, the sidewall 231 and the flange 239 intersect the sidewall 233 and the flange 241 at a corner C3, and the sidewall 233 and the flange 241 intersect the sidewall 227 and the flange 235 at a corner C4.

Referring additionally to FIG. 8, in use, the construct 200 can be exposed to the heat source H such that a high heat environment surrounds the construct 200 a high temperature, for example, about 400° F. (204° C.) and above, e.g., between and including about 400° F. (204° C.) and about 450° F. (232° C.), for example, 400° F. (204° C.), 405° F. (207° C.), 410° F. (210° C.), 415° F. (213° C.), 420° F. (216° C.), 425° F. (218° C.), 430° F. (221° C.), 435° F. (224° C.), 440° F. (227° C.), 445° F. (229° C.), 450° F. (232° C.), or other integer or non-integer temperatures therebetween, to name a few. As described above with respect to the construct 100 (FIG. 6), the film 104 substantially maintains its integrity and dimensional and/or positional properties and the adhesive 106 substantially maintains its integrity and dimensional and/or positional properties in the presence of a high heat or high temperature environment provided by the heat source H such that the construct 200 substantially resists deformation, e.g., shrinking, warping, curling, and/or disintegration, at high temperatures, e.g., between about 400° F. (204° C.) and about 450° F. (232° C.). In addition, delamination of the laminate structure 102 (FIG. 4) that forms the construct 200 is substantially inhibited in such high heat environments or high temperatures as described above with regard to the construct 100 (FIG. 5). It will be understood that the construct 200 can be exposed to temperatures less than about 400° F. (204° C.) and the film 104 and adhesive 106 will maintain their respective integrity and dimensional and/or positional properties as described above. In one embodiment, the construct 200 can be exposed to temperatures greater than about 450° F. (232° C.).

In this regard, the constructs 100, 200 include a base layer 108 that can be, for example, paperboard, and which is provided with thermally stable e.g., heat-resistant, properties due to the configurations of the film 104 and adhesive 106 such that the constructs 100, 200 can be subject to high heat or high temperatures, e.g., temperatures between about 400° F. (204° C.) and about 450° F. (232° C.), substantially without deformation. Such constructs 100, 200 can thus be constructed of economical materials that can be, for example, obtained at low cost and/or discarded following use. In one embodiment, the constructs 100, 200 are reusable products.

While the constructs 100, 200 have been illustrated in a press-formed tray-like configuration, in other embodiments, the constructs 100, 200 can have a different configuration for example, a container, package, sleeve, tray, plate, bowl, mat, or an enclosure, to name a few, and can be formed in a different manner. In one embodiment, the constructs 100, 200 can be a bowl, tray, or pan.

In general, the base layers described herein may be constructed from paperboard having a caliper so that it is heavier and more rigid than ordinary paper. The base layer can also be constructed of other materials, such as cardboard, or any other material having properties suitable for enabling the construct to function at least generally as described above. The base layer can be coated with, for example, a clay coating. The clay coating may then be printed over with product, advertising, and other information or images. The base layers may then be coated with a varnish to protect information printed on the base layers. The base layers may also be coated with, for example, a moisture barrier layer, on either or both sides of the base layers. The base layers can also be laminated to or coated with one or more sheet-like materials at selected panels or panel sections.

The foregoing description of the disclosure illustrates and describes various embodiments. As various changes could be made in the above construction without departing from the scope of the disclosure, it is intended that all matter contained in the above description or shown in the accompanying drawings shall be interpreted as illustrative and not in a limiting sense. Furthermore, the scope of the present disclosure covers various modifications, combinations, alterations, etc., of the above-described embodiments. Additionally, the disclosure shows and describes only selected embodiments, but various other combinations, modifications, and environments are within the scope of the disclosure as expressed herein, commensurate with the above teachings, and/or within the skill or knowledge of the relevant art. Furthermore, certain features and characteristics of each embodiment may be selectively interchanged and applied to other illustrated and non-illustrated embodiments of the disclosure.

The foregoing description illustrates and describes various embodiments of the disclosure. As various changes could be made in the above construction, it is intended that all matter contained in the above description or shown in the accompanying drawings shall be interpreted as illustrative and not in a limiting sense. Furthermore, various modifications, combinations, and alterations, etc., of the above-described embodiments are within the scope of the disclosure. Additionally, the disclosure shows and describes only selected embodiments, but various other combinations, modifications, and environments are within the scope of the disclosure, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A laminate structure, comprising:
a base layer;
a thermally stable adhesive disposed on at least a portion of the base layer; and
a thermally stable film overlying the base layer and the adhesive, the thermally stable film and the thermally stable adhesive are configured such that the laminate structure substantially resists deformation at a temperature of about 400° F. (204° C.) and above.

2. The laminate structure of claim 1, wherein the laminate structure substantially resists deformation at a temperature between about 400° F. (204° C.) and about 450° F. (232° C.).

3. The laminate structure of claim 1, wherein the base layer is comprised of paperboard.

4. The laminate structure of claim 3, wherein the thermally stable film is comprised of a polymeric material.

5. The laminate structure of claim 4, wherein the thermally stable film is comprised of polyester.

6. The laminate structure of claim 4, wherein the thermally stable film is comprised of polyethylene terephthalate.

7. The laminate structure of claim 4, wherein the thermally stable adhesive is comprised of a crosslinked polymeric material.

8. The laminate structure of claim 7, wherein the thermally stable adhesive comprises a crosslinking agent in an amount between about 0.25% and about 5.0% by weight of the thermally stable adhesive.

9. The laminate structure of claim 1, wherein the thermally stable adhesive is comprised of a crosslinked polymeric material.

10. The laminate structure of claim 9, wherein the thermally stable adhesive comprises a crosslinking agent in an amount between about 0.25% and about 5.0% by weight of the thermally stable adhesive.

11. The laminate structure of claim 1, wherein the laminate structure substantially resists weakening at a temperature between about 400° F. (204° C.) and about 450° F. (232° C.).

12. The laminate structure of claim 1, wherein the laminate structure substantially resists delamination at a temperature between about 400° F. (204° C.) and about 450° F. (232° C.).

13. A construct for holding at least one food product, comprising:
a press-formed laminate structure comprising a bottom and at least one sidewall extending upwardly from the sidewall and extending at least partially around an interior of the construct, the laminate structure comprising:
a base layer;
a thermally stable adhesive disposed on at least a portion of the base layer; and
a thermally stable film overlying the base layer and the adhesive, the thermally stable film and the thermally stable adhesive are configured such that the laminate structure substantially resists deformation at a temperature of about 400° F. (204° C.) and above.

14. The construct of claim 13, wherein the construct substantially resists deformation at a temperature between about 400° F. (204° C.) and about 450° F. (232° C.).

15. The construct of claim 13, wherein the base layer is comprised of paperboard.

16. The construct of claim 15, wherein the thermally stable film is comprised of a polymeric material.

17. The construct of claim 16, wherein the thermally stable film is comprised of polyester.

18. The construct of claim 16, wherein the thermally stable film is comprised of polyethylene terephthalate.

19. The construct of claim 16, wherein the thermally stable adhesive is comprised of a crosslinked polymeric material.

20. The construct of claim 19, wherein the thermally stable adhesive comprises a crosslinking agent in an amount between about 0.25% and about 5.0% by weight of the thermally stable adhesive.

21. The construct of claim 13, wherein the thermally stable adhesive is comprised of a crosslinked polymeric material.

22. The construct of claim 21, wherein the thermally stable adhesive comprises a crosslinking agent in an amount between about 0.25% and about 5.0% by weight of the thermally stable adhesive.

23. The construct of claim 13, wherein the construct substantially resists weakening at a temperature between about 400° F. (204° C.) and about 450° F. (232° C.).

24. The construct of claim 13, wherein the construct substantially resists delamination at a temperature between about 400° F. (204° C.) and about 450° F. (232° C.).

25. A method of forming a laminate structure, the method comprising:
obtaining a base layer;
disposing a thermally stable adhesive on at least a portion of the base layer; and
applying a thermally stable film overlying the base layer and the adhesive, the thermally stable film and the thermally stable adhesive are configured such that the laminate structure substantially resists deformation at a temperature of about 400° F. (204° C.) and above.

26. The method of claim 25, wherein the laminate structure substantially resists deformation at a temperature between about 400° F. (204° C.) and about 450° F. (232° C.).

27. The method of claim 25, wherein the base layer is comprised of paperboard.

28. The method of claim 27, wherein the thermally stable film is comprised of a polymeric material.

29. The method of claim 28, wherein the thermally stable film is comprised of polyester.

30. The method of claim 28, wherein the thermally stable film is comprised of polyethylene terephthalate.

31. The method of claim 28, wherein the thermally stable adhesive is comprised of a crosslinked polymeric material.

32. The method of claim 31, wherein the thermally stable adhesive comprises a crosslinking agent in an amount between about 0.25% and about 5.0% by weight of the thermally stable adhesive.

33. The method of claim 25, wherein the thermally stable adhesive is comprised of a crosslinked polymeric material.

34. The method of claim 33, wherein the thermally stable adhesive comprises a crosslinking agent in an amount between about 0.25% and about 5.0% by weight of the thermally stable adhesive.

35. The method of claim 25, wherein the laminate structure substantially resists weakening at a temperature between about 400° F. (204° C.) and about 450° F. (232° C.).

36. The laminate structure of claim 25, wherein the laminate structure substantially resists delamination at a temperature between about 400° F. (204° C.) and about 450° F. (232° C.).
